(19) United States
(12) Patent Application Publication
(10) Pub. No.: US 2004/0266537 A1
(43) Pub. Date: Dec. 30, 2004

(54) Decorations and methods for decorating cables

(76) Inventor: Richard D. Morris, Atlanta, GA (US)

Correspondence Address: TECHNOPROP COLTON, L.L.C., P O BOX 567685, ATLANTA, GA, 311567685

(21) Appl. No.: 10/607,253

(22) Filed: Jun. 27, 2003

(51) Int. Cl. G06F 17/00

(52) U.S. Cl. 463/47

(57) ABSTRACT

A decorative assembly for a cable of a video game system.

### BACKGROUND OF THE INVENTION

1. Technical Field

This invention generally relates to the field of decorations and adornments and methods for decorating and adorning cables and more particularly to the field of decorations and adornments and methods for decorating and adorning the cables of computers, video game systems, or the like. Additionally, this invention generally relates to the field of awards, tokens, indicia, and other indications of achievement, fanaticism, or devotion and more particularly to the field of providing, awarding, winning, trading, and otherwise distributing awards, tokens, indicia, and other indications of achievement, fanaticism, or devotion.

2. Prior Art.

Several cables typically connect the hardware components of a typical computer or video game system together. For example, one cable usually connects the monitor to the central processing unit (CPU) or video game console, another cable usually connects the controllers (e.g. mouse, joystick, keyboard or game controller) to the CPU, and so forth. As more hardware is added to the system, the cables of the system become more prevalent and become more noticeable by the users of the system. Despite the ubiquitous nature of cables on computers and video game systems, the industry has yet to discover any uses (other than its intended use) for the cables or any ways to render the cable more aesthetically pleasing.

Accordingly, there is a need for devices and methods for making additional use for the cables on computers and video game systems. There also is a need for devices and methods to render the cables more aesthetically pleasing. There is an additional need for devices and methods for decorating and adorning cables with awards, tokens, indicia, and other indications of achievement, fanaticism, or devotion and for providing, awarding, winning, trading, and otherwise distributing awards, tokens, indicia, and other indications of achievement, fanaticism, or devotion. There is a further need for such devices and methods to not affect the performance or function of the cable. It is to these needs, among others, that the present invention is directed.

### BRIEF SUMMARY OF THE INVENTION

Briefly, the present invention generally are decorations for placing about the cables of computers or video game systems, methods for decorating such cables, and methods of distributing or otherwise providing such decorations. Illustrative embodiments of the devices of present invention include decorations comprising a decorative assembly having a means for attaching the decorative assembly to a cable of a computer or video game system. Illustrative embodiments of the methods for decorating cables of the present invention include placing one or more decorative assemblies about a cable of the computer or video game system, for example, the cable extending from the CPU or video game console to the game controller. Illustrative embodiments of the of the methods of distributing or otherwise providing such decorations of the present invention include distributing the decorations with video games, distributing the decorations individually or in sets, distributing or trading the decorations at conferences or trade shows, distributing, trading or awarding the decorations at tournaments, and distributing or awarding the decorations upon an achievement or other accomplishment.

The decoration, generally referred to herein as a decorative assembly, is attached to a cable that can be previously installed on the computer or video game system. Thus, the user can install the decorative assembly about the cable without having to disengage the cable from the components of computer or video game system. Preferably, the decorative assembly is removable from the cable without undue effort. One advantage of the decorative assembly being removable is that it allows the decorative assembly to be removed and placed about another cable. However, it is also contemplated that the decorative assembly can be made for a single use, that is, the decorative assembly could manufactured so that decorative assembly cannot be removed post-installation without damaging the assembly itself.

One advantage of the decorative assembly of the present invention, in one preferred embodiment, is that it can be placed relatively securely on a cable without impairing the function of the cable. More specifically, as the decorative assembly is not meant to penetrate the surface of the cable, there is limited danger that cable will be impaired functionally by the decorative assembly. Further, because the decorative assembly is placed about the cable and does not affect or otherwise impinge on the inner workings of the cable, the decorative assembly does not impair the function or use of the attached component.

In one illustrative embodiment of the methods for decorating cables of the present invention, a user can place more than one decorative assembly on a single cable. For example, as a user earns, is awarded, purchase, or otherwise obtains additional decorative assemblies, the user can place these additional decorative assemblies about the cable. Further, as a user can remove the decorative assembly from the cable by opening the decorative assembly thereby releasing the cable, a user can replace selectively the decorative assemblies previously placed on the cable. The number of decorative assemblies that can be placed on a cable is limited only by the size of the decorative assemblies and the length of the cable. More specifically, the number of additional decorative assemblies that can be place on a cable is limited to size of the space remaining on the cable.

Illustrative embodiments of the decorative assembly of the present invention can have an array of shapes, styles, colors, and markings. For example, in one embodiment, the decorative assembly can be shaped like objections such sports memorabilia, video game figures, or aesthetically pleasing objects. In another embodiment, the decorative assembly can have markings that can be selected from an array of information, advertisements, and aesthetics displays. In another embodiment, the decorative assembly can comprise award or reward information related to a variety of matters, such as personal, professional, or competitive achievements or accomplishments. The shapes, styles, colors, markings, or combinations thereof are limited only by the human imagination.

The present invention can allow a cable to serve as an archive of person's history, events, and/or achievements. More particularly, as the decorative assemblies around the cable can represent past achievements and events, the series of decorative assemblies around the cable can provide a historical record of such achievements and events. As such, a user can display his achievements to others by pointing others to his cable and the display of decorative assemblies thereon.

The present invention can be packaged and distributed in array of fashions. In one illustrative embodiment, the decorative assembly is provided along with a video game in a single package. In another embodiment, the decorative assembly can be provided in a package only consisting of one or more decorative assemblies. In still another embodiment, the decorative assembly can be provided as a memento of attendance at an event, achievement of a goal, accomplishment of a task, or the like. One of ordinary skill in the art can create innovative methods for distributing the decorative assembly.

An illustrative embodiment of a method for decorating a cable of a computer or video game system of the present invention comprises the basic steps of (1) obtaining a decorative assembly and (2) placing the decorative assembly on the cable. As the cable generally can accommodate more than one decorative assembly, the general method can be repeated until the maximum number of decorative assemblies is placed around cable.

For example, in one embodiment of a method for decorating a cable of a computer or video game system of the present invention, a manufacturer of a video game can selectively distribute a decorative assembly when a person achieves a specific level or status in a game. For example, such a system for selectively distributing a decorative assembly can be set up comprising the steps of (1) a person achieves a specific level or status in a game, (2) upon achieving the specific level or status, the video game provides the player with a unique code or password, (3) the user submits (e.g. via a website) the code or password to a specific enterprise, which may or may not be sanctioned by the video game manufacturer; (4) the enterprise, after authenticating the code or password, can send a decorative assembly commemorating the achievement to the player; and (5) once the player obtains the decorative assembly, the player places the decorative assembly about the cable. Such a system can provide for the selective distribution of decorations.

For another example, in another embodiment of a method for decorating a cable of a computer or video game system of the present invention, the winner of a video game tournament can be awarded a decorative assembly, or can claim the decorative assembly owned by his or her opponent. For example, such a system for awarding a decorative assembly can be set up comprising the steps of (1) a person wins a video game tournament, (2A) the winner is awarded a decorative assembly from the tournament sponsor or other entity or (2B) the winner claims the decorative assembly owned by his or her defeated competitor; and (3) once the player obtains the decorative assembly, the player places the decorative assembly about his or her cable. Such a system can provides for the selective award of decorations.

These features, and other features and advantages of the present invention will become more apparent to those of ordinary skill in the relevant art when the following detailed description of the preferred embodiments is read in conjunction with the appended drawings in which like reference numerals represent like components throughout the several views.

### BRIEF DESCRIPTION OF THE DRAWINGS

FIG. 1 is perspective view of one embodiment of several decorative assemblies of the present invention placed on the cables of a video game system.

FIG. 2 is a view of an illustrative embodiment of an example decorative assembly as shown in FIG. 1.

FIG. 3 is a rear view of the component of the embodiment in FIG. 1.

FIG. 4 is an enlarged view of the decorative assembly shown in FIGS. 1 and 2 in an assembled condition on a cable.

FIG. 5 is a view of a cable as an archive of various embodiments of the decorative assembly of the present invention.

FIG. 6A is another embodiment of the decorative assembly of the present invention illustrating alternative shapes.

FIG. 6B is another embodiment of the decorative assembly of the present invention illustrating alternative shapes.

FIG. 6C is another embodiment of the decorative assembly of the present invention illustrating alternative shapes.

FIG. 7A is another embodiment of the decorative assembly of the present invention illustrating alternative marking.

FIG. 7B is another embodiment of the decorative assembly of the present invention illustrating alternative marking.

FIG. 7C is another embodiment of the decorative assembly of the present invention illustrating alternative marking.

FIG. 8 is an embodiment of a method for distributing the decorative assembly of the present invention.

FIG. 9 is another embodiment of a method for distributing the decorative assembly of the present invention.

FIG. 10 is flow diagram of an illustrative method for selectively distributing a decorative assembly of the present invention.

FIG. 11 is flow diagram of another illustrative method for selectively distributing a decorative assembly of the present invention.

### PREFERRED EMBODIMENTS OF THE PRESENT INVENTION

In this specification and claims, the term “decorative assembly” includes any addition to a cable that is not directly connected with the function of a cable. For example, an addition would not be a “decorative assembly” if its sole purpose is functional, such as to identify the cable for proper connection to other hardware.

Unless otherwise defined, all other terms used herein have the same meaning as commonly understood by one of ordinary skill in the art to which this invention pertains. Although methods and materials similar or equivalent to those described herein can be used in the practice and testing of the present invention, suitable methods and materials are described below. In addition, the materials, methods, and examples are illustrative only and not intended to be limiting.

Illustrative embodiments of the present invention are decorations and decorative assemblies, methods for decorating a cable of a video game system or computer (hereinafter collectively “video game system”), and methods for distributing or providing decorative assemblies to users. This specification provides several illustrative embodiments of the decorative assemblies and methods, a primary embodiment of which is to provide users with a means to alter the appearance of a video game system cable should the user desire. While the invention is described herein in conjunction with the preferred and illustrative embodiments, it will be understood that the invention is not limited to these embodiments.

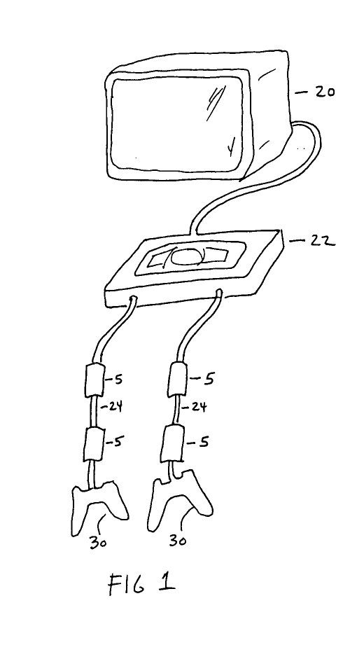

Referring now to FIG. 1, one illustrative embodiment of the present is decorative assembly 10 that fits about cable 24 of video game system 5. In this embodiment, decorative assembly 10 is placed about cable 24 of video game system 5, which can, for example, extend from processing console 22 to game controller 30. As cable 24 can be previously in place, the user can install decorative assembly 10, preferably with only finger pressure and force, about cable 24 without having to disengage cable 24 from the components of video game system 5. As disclosed in more detail below, decorative assembly 10 can be any device that can be used to decorate or adorn cable 24, and preferably is a device designed and manufactured to commemorate an event, achievement, accomplishment or the like; to display allegiance, devotion, or emotion to an organization, cause, person or the like; or simply to decorate an otherwise bland functional item, namely cable 24.

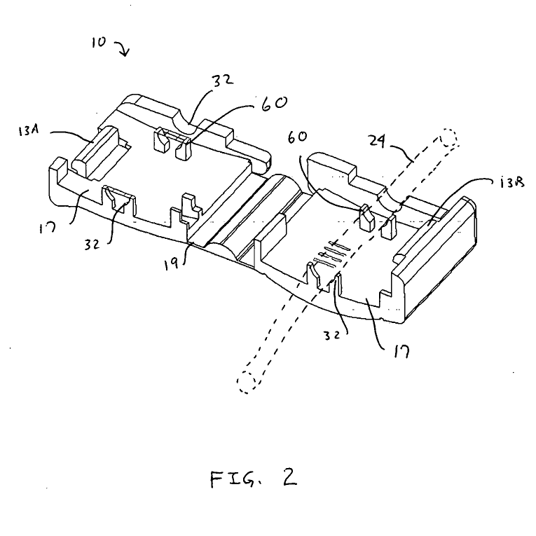

Referring now to FIG. 2, a preferred embodiment of decorative assembly 10 comprises two sections 17 that are more readily seen when decorative assembly 10 is in the open position shown. As shown, the two sections 17 are connected one side by one or more hinges 19, which allow sections 17 to be pivotally connected about hinges 19. On the side opposite to hinges 19 are one or more of tabs 13A and groves 13B, which allow the sections 17 to be reversibly joined to one another. Preferably, the two sections 17 are mirror images of each other and enclose about cable 24.

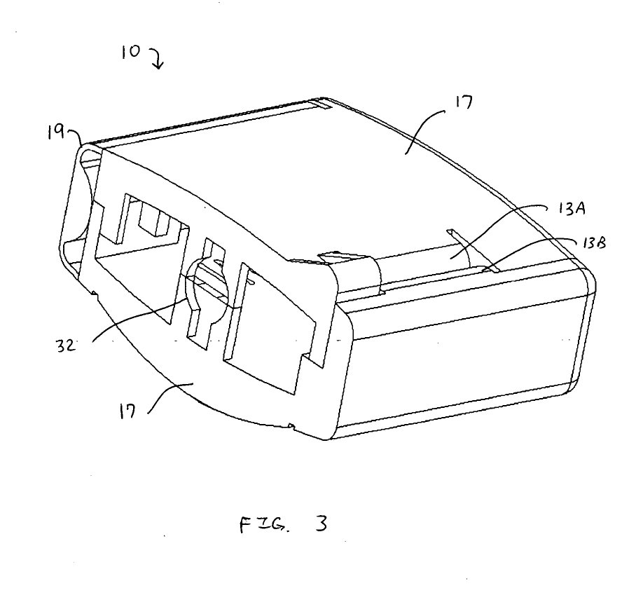

Referring now to FIG. 3, the inside of two sections 17 can comprise one or more stabling members 32 which abut cable 24 in a closed configuration. Each stabilizing member 32 has arcuate indentations 34 that are cable of cooperating with an outer surface of cable 24. More particularly, stabilizing members 32 form an axially extending channel-like support for supporting cable 24 in place within decorative assembly 10. As such, stabilizing member 32 reduce the degrees of freedom around cable 24.

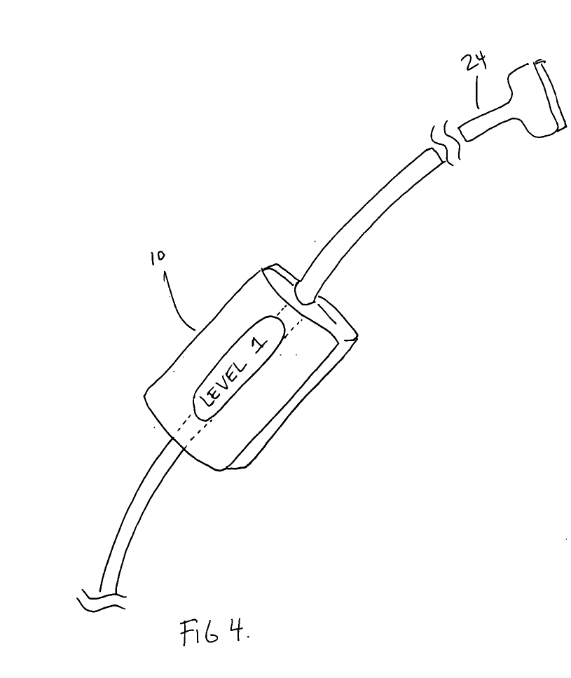

Referring now to FIG. 4, to install decorative assembly 10 about cable 24, sections 17 are placed proximate to cable 24 and pivoted from the open position (shown in FIG. 2) to a closed position (shown in FIG. 3) about cable 24. More particularly, sections 17 of decorative assembly 10 in the open position are in a split position and are placed over cable 24 so as to partially surround cable 24. Then sections 17 are pivoted about hinges 19 in manner so that sections 17 capture cable 24 within stabilizing members 32. After sections 17 have been placed together, sections 17 are locked together using integrating tabs 13A and grooves 13B. In a closed position, only the outside of each section 17 is visible to ordinary observers.

Preferably, decorative assembly 10 is removable from cable 24 without undue effort, and can be placed on and removed from cable 24 at will. To remove decorative assembly 10 from cable 24, a user can unlock sections 17 of decorative assembly 10 and remove decorative assembly 10 from cable 24. One advantage of the removability of decorative assembly 10 from cable 24 is that it allows decorative assembly 10 to be removed from one cable and placed on another cable of choice. However, it is also contemplated that decorative assembly 10 can be made for a single use, that is, decorative assembly 10 could be manufactured so that decorative assembly 10 cannot be removed without damaging the assembly itself.

One advantage of this embodiment is that decorative assembly 24 can be placed relatively securely on cable 24 without impairing the function of cable 24. As decorative assembly 10 does not penetrate or otherwise negatively affect cable 24, there is limited chance that cable 24 will be functionally impaired. Further, decorative assembly 10 is placed on cable 24 such that decorative assembly 10 does not impair the function or use of game controller 30. Preferably, decorative assembly 10 is able to capture cable 24 without over compressing the material of cable 24.

In a closed position, decorative assembly 10 may be moved along cable 24. Preferably, decorative assembly 10 fits snuggly around cable 24 when in a closed position so that, if in a movable embodiment, it can be moved along cable 24 without appearing loose. If decorative assembly 10 fits excessively tightly against the cable 24, decorative assembly 10 may press into cable 24 and make it difficult to move decorative assembly 10 along cable 24. Alternatively, if decorative assembly 10 is not tight enough against cable 24, decorative assembly 24 may be able to move excessively along cable 24. One of ordinary skill in the art can select an optimal amount of tension against cable 24 based on preferences.

An illustrative embodiment of decorative assembly as shown in FIGS. 2-4 can comprise a pair of generally semi-cylindrical half-shell shaped sections 17 having a length greater than, less than or equal to their diameter and hingedly connected along one edge by hinge 19. As disclosed above, hinge 19 can be a common hinge, but also can be formed by a region of reduced thickness defining an integrally formed hinge 19. An edge of the half-shell section 17 can be formed with one or more generally tangentially directed tabs 13A. The corresponding edge of the other half-shell section 17 can be formed with a groove 13B. Alternatively, tongue and slot pairs can be used. Preferably, moderate finger pressure is sufficient to snap-engage the tab 13A and groove 13B together as shown in FIG. 3 to hold the two sections 17 together. Thus cable 14 may be placed in one half of the decorative assembly 24, the other half of decorative assembly 24 may be hinged around to entrap cable 24, and finger pressure is then applied to push the tab 13A home. The internal diameter of the assembled decorative assembly 24 preferably is equal to or slightly greater than the outside diameter of the intended cable 24. For more positive axial location, the inner faces of the half-shell sections 17 can be formed with ribs 60 that bite on, but do not over-compress, cable 24. At least one of sections 17 preferably is formed on its outer face with a legible decorative marking or shape. The outer face of the other section 17 also can be decorated, but also can be unadorned.

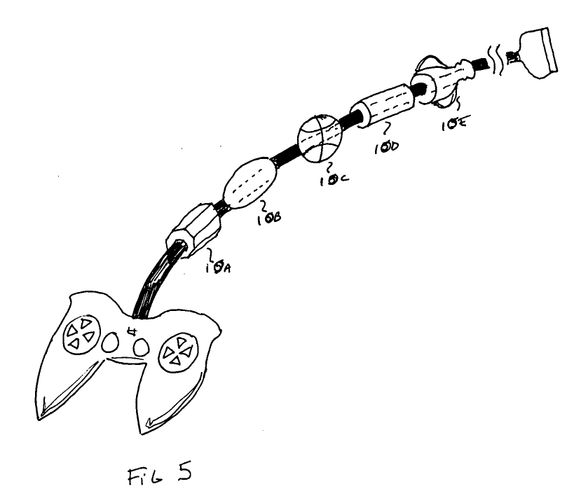

Referring now to FIG. 5, a user can place more than one decorative assembly 10, such as decorative assemblies 10A-F, along cable 24. For example, as a user earns or obtains additional decorative assemblies 10, the user can place the additional decorative assemblies 10 on cable 24. Further, as a user can remove decorative assemblies 10 from cable 24 by opening each decorative assembly 10 that thereby releasing cable 24, a user can replace decorative assemblies 10 previously placed on cable 24. The number of decorative assemblies 10 that can be placed on cable 24 is limited only by the size of decorative assemblies 10 and the length of cable 24. More specifically, the number of decorative assemblies 10 is limited to size of the space remaining on cable 24.

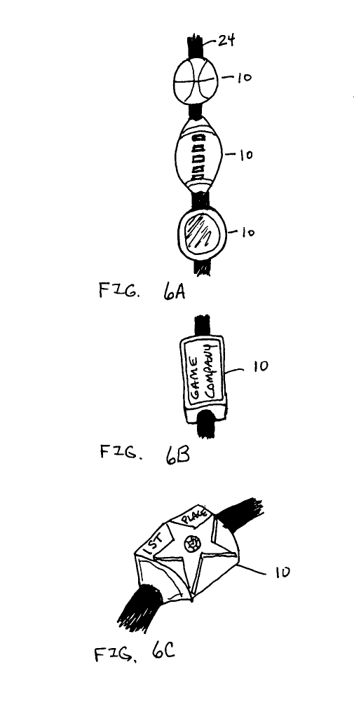

Referring now to FIGS. 6A-C, decorative assembly 10 can have an array of shapes limited only by the human imagination. As shown in FIG. 6A, in one embodiment, decorative assembly 10 can be shaped like objects such as footballs, basketballs, or hockey pucks, which could be used to show that a person is a fan of or has achieved a status in a sport such as football, basketball, or hockey, respectively. As shown in FIG. 6B, in another embodiment, decorative assembly 10 can be shaped as video game figures, which could be used to show that a person is a fan of or has achieved a status in a video game. As shown in FIG. 6C, in another embodiment, decorative assembly 10 can be in the shape of aesthetically pleasing objects, which can be used to improve the aesthetics of cable 24. One of ordinary skill in the art can develop specific designs that are compatible with decorative assembly 10.

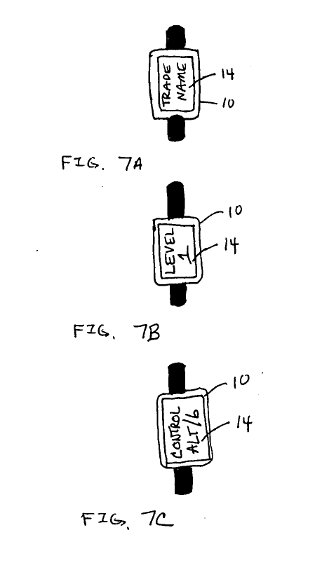

Referring now to FIGS. 7A-C, decorative assembly 10 can comprise features, shapes, designs, or other markings 14 that can be selected from an array of information, advertisements, and aesthetics displays. Such markings 14 of the present invention can be selected from a wide variety of markings, including for illustrative purposes cartoon characters, action figures, sports equipment, artist renditions, video game characters or themes, and the like, that are attractive to children, adults, or both. In one embodiment, shown in FIG. 7A, marking 14 can simply be the name of a video game or trade name of an entity. In another embodiment, marking 14 can indicate a particular level achieved in a particular activity or video game. In another embodiment, shown in FIG. 7B, marking 14 can be related to events in which decorative assemblies 10 are distributed to users. In another embodiment, shown in FIG. 7C, markings 14 can be codes or instructions for playing a particular video game. In another embodiment, decorative assembly 14 itself can be considered a marking 14 by being orange to represent successful attainment of an orange belt in a martial art. One of ordinary skill in the art can select markings 14 to be placed on decorative assembly 10 based on preferences and/or commercial choices. As can be seen, the wide array of decorative assembly 10 provides a valuable tool for decorating cable 24 of video game system 5.

As can be seen, the shape, color, and materials of decorative assembly 10 can be widely varied. Further, the decorative assembly 10 can be manufactured from colored materials, or materials that can be colored. Alternative materials such as glow-in-the-dark materials also are contemplated. As an optional accessory, separate or integrated lighting devices, such as diodes or flashlights, can be supplied with or integrated into decorative assembly 10.

Another embodiment of the present invention includes a general method for decorating a cable 24, comprising the steps of:

(1) obtaining a decorative assembly 10; and

(2) placing decorative assembly 10 on cable 24.

As cable 24 can accommodate more than one decorative assembly 10, the general method can be repeated until the maximum number of decorative assemblies 10 is placed around cable 24, or until cable 24 is decorated to the satisfaction of the user.

Utilizing this general method, cable 24 with decorative assembly 10 can serve to archive a person's history. More particularly, as decorative assembly 10 about cable 24 can represent past achievements and events, the series of decorative assembly 10 about cable 24 provides a historical record of such achievements and events. As such, a user can display his or her achievements or his or her archived history to others by displaying or directing others to his cable 24.

Similarly, the user can use decorative assemblies 10 to show that user is a fan. Thus, using the method, the user can show he or she is a fan of one rock star this week, and then can add or change decorative assemblies 10 to show he or she is a fan of an additional or different rock star the next week. Thus, the general method of decorating cable 24 can be adjusted to include step (3) of adding one or more additional decorative assemblies 10 to cable 24 or replacing one decorative assembly 10 with a different decorative assembly 10.

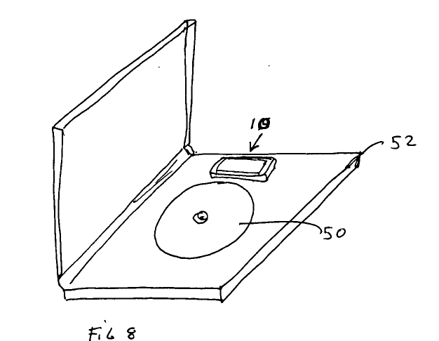

Referring now to FIG. 8, a first method for providing, awarding, winning, trading, and otherwise distributing awards, tokens, indicia, and other indications of achievement, fanaticism, or devotion is shown. In one illustrative embodiment, decorative assembly 10 can be sold with video game 50 in package 52. More specifically, decorative assembly 10 could be placed in package 52 and distributed as a single unit. By providing decorative assembly 10 with video game 50, decorative assembly 10 is given to a user or buyer in a discriminate manner. It is contemplated that decorative assembly 10 could be unique to video game 50 and may in some cases be a limited edition. For example, each decorative assembly 10 issued with video game 50 can have a unique serial number to ensure the authenticity of such decorative assemblies 100. The user could then place decorative assembly 10 on cable 24 after opening the package. Thus, if a user is a fan of a certain video game, when purchasing the video game or a special edition of the video game, the package for the video game can include a decorative assembly 10 unique to the video game. The user then could place decorative assembly 10 on cable 24 when playing the video game.

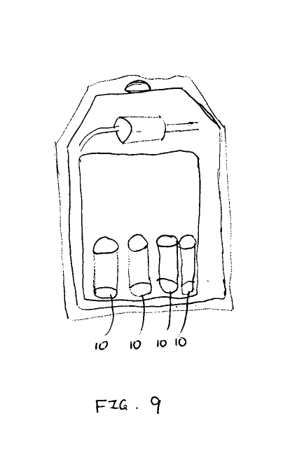

Referring now to FIG. 9, decorative assembly 10 can be sold as a package of decorative assemblies 10. In such an embodiment, a user or buyer could buy a package 54 of decorative assemblies 10 and distribute then to various people. For example, an entity could hold a competition and dispute decorative assemblies 10 to its winners or to all competitors. For another example, decorative assembly 10 could be purchased and simply distributed at will to other people as gifts. For another example, the package of decorative assemblies 10 could be purchased and distributed as a single unit.

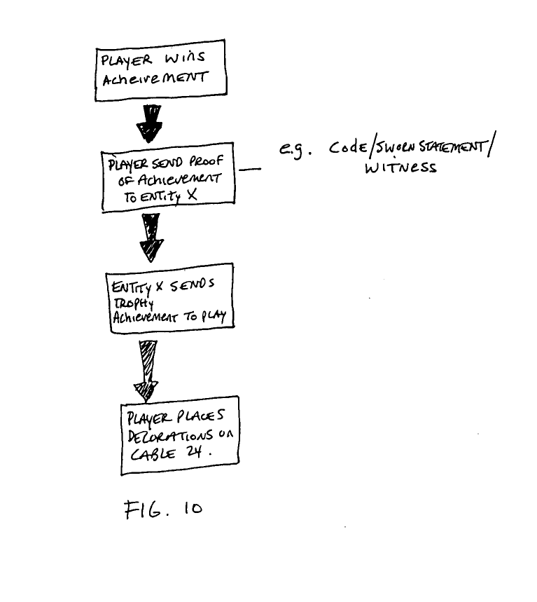

Referring now to FIG. 10, decorative assembly 10 could be selectively distributed by a manufacturer of a video game when a person achieves a specific level or wins a game. For example, a method for selectively distributing the decorative assemblies 10 can be set up comprising the following steps:

(1) A person achieves a specific level or status in a game;

(2) Upon achieving the specific level or status, the video game is programmed to provide the player with a unique code or password;

(3) The user submits (e.g. via a website) the code or password to a specific enterprise, which may or may not be sanctioned by the video game manufacturer;

(4) The enterprise, after authenticating the code or password, can send a decorative assembly 10 commemorating the achievement to the player (possibly for a fee, in a commercial business method); and

(5) Once the player obtains the decorative assembly 10, the user can place the decorative assembly 10 on cable 24.

Such a method rewards achievement by people in video games, or other computer games, or indeed any type of game or sport, to obtain decorative assembly 10 and allows the achiever to have proof of his or her achievement by showing others the unique decorative assembly 10. The achiever than can adorn his or her cable 24 at home with the awarded decorative assembly 10.

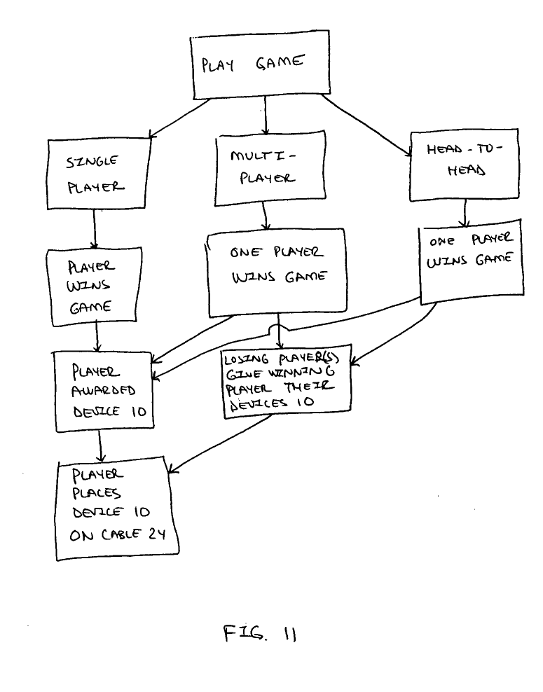

Referring now to FIG. 11, decorative assembly 10 can be won or lost by game players. For example, a method for using decorative assembly 10 as a trophy or prize can be set up comprising the following steps:

(1) One or more persons compete with each other in a game, such as a video game. Such competitions can be as small as private competitions between two people in a home to as large as multi-person competitions at a bar or convention; and

(2) Upon winning a game, the winner is given a decorative assembly by the loser, or is awarded a decorative assembly by the competition sponsor or the video game developer.

Such a method rewards victory in competition by people in video games, or other computer games, or indeed any type of game or sport, and to obtain the decorative assembly 10 of others, namely the loser or losers. This method allows the winner to have proof of his or her victories by showing others the unique decorative assembly 10 he or she won.

As an additional embodiment, a method for registering decorative assemblies 10 is contemplated. Each decorative assembly 10 can be manufactured with a unique serial number or other identifying number or device, or a sticker or other indicia source having a unique serial number or other identifying number or device can be placed on or within, or otherwise attached to, each decorative assembly 10. When a user or player buys, trades, wins, or otherwise obtains a decorative assembly 10, the user or player can register the unique serial number or other identifying number or indicia with one or more databases, such as over the Internet. The operators of the databases can use this information for give-aways, contests, keeping track of contest and game winners, promotional activities, scoring contests, and the like.

Decorative assembly 10 can be manufactured relatively easily with inexpensive and/or expensive materials. In one embodiment, if decorative assembly 10 is intended to be manufactured cheaply, decorative assembly 10 can be formed of plastic, metal, or other inexpensive materials. In another embodiment, if decorative assembly 10 is intended to be a commodity or prize, decorative assembly 10 can be made from precious materials such as platinum, gold, silver, or bronze. Such plastics, metals, and other materials are known in the art.

As discussed herein, marking 14 can be placed onto decorative assembly 10 through numerous methods. For example, marking 14 can be on a sticker that is adhered to decorative assembly 10. For another example, marking 14 can be burned or branded onto decorative assembly 10. For another example, marking 14 can be molded on decorative assembly 10. For another example, decorative assembly 10 can be marking 14 itself by molding the entire decorative assembly 10 in a desired shape, such as a football. One of ordinary skill in the art can determine methods for placing information on decorative assembly 10 without undue experimentation.

The means for attaching decorative assembly 10 to cable 24 also are numerous. For example, as shown in FIG. 1, the means for attaching decorative assembly 10 about cable 24 comprises the hinge 17 and tab 13A and groove 13B combination to permit sections 17 to be locked in the closed position. For another example, the sections 17 may be coupled together using a system of interlocking grooves. One of ordinary skill in the art can develop system for locking sections 17 together without undue experimentation.

While the exemplary video game system 5 disclosed herein is very general and comprises only the basil elements of a video system, it is understood that video game systems that can operate with the present invention are numerous and can have various additional components. Video game systems that can be computer, including those manufactured Dell®) or Compaq®, as well as video game systems, including those manufactured by Sony®, Microsoft®, or Nintendo®.

It is understood that decorative assembly 10 can be placed on any cable 24 of a video game system 5. While decorative assembly 10 is shown to be placed around cable 24 from controller 30 to CPU 20, decorative assembly 10 could be placed any other cable 24 of a video game system 5. For example, decorative assembly 10 could have been placed on cable 24 from the monitor to the CPU 20 or on the cable 24 from the CPU 20 to the power source. A user can place decorative assembly 10 on a cable 24 as he or she desires.

The foregoing detailed description of the preferred embodiments and the appended figures have been presented only for illustrative and descriptive purposes and are not intended to be exhaustive or to limit the scope and spirit of the invention. The embodiments were selected and described to best explain the principles of the invention and its practical applications. One of ordinary skill in the art will recognize that many variations can be made to the invention disclosed in this specification without departing from the scope and spirit of the invention.

What is claimed is:

1. A device for decorating a cable comprising:
a. a decorative assembly; and
b. a means for placing the decorative assembly about the cable.

2. The device as claimed in claim 1, wherein the cable is part of a video game system.

3. The device as claimed in claim 2, wherein the cable connects a game controller to a processing console.

4. The device as claimed in claim 1, further comprising at least one marking.

5. The device as claimed in claim 1, wherein the decorative assembly comprises two sections.

6. The device as claimed in claim 5, wherein the two sections are attached by at least one hinge, the sections are pivotal about the at least one hinge between an open position and a closed position, and the sections are pivoted towards each other to capture the cable therewithin when in the closed position.

7. The decoration as claimed in claim 1, wherein the device is included with a video game.

8. The device as claimed in claim 1, wherein a plurality of the devices is supplied in a single package.

9. The device as claimed in claim 6, wherein the device comprises two sections that are connected by at least one hinge that allows a first of the two sections to be pivotally connected to a second of the two sections, a portion of the hinge being located on a first side of each of the two sections.

10. The device as claimed in claim 9, wherein on a second side of each of the two sections is a connecting means that allow the two sections to be reversibly connected to one another.

11. The device as claimed in claim 10, wherein the two sections are mirror images of each other.

12. The device as claimed in claim 6, wherein at least one of the two sections comprises an internal stabling member that abuts the cable in the closed configuration.

13. The device as claimed in claim 1, wherein the device further comprises a unique serial number.

14. A device for decorating a cable that is a part of a video game system, the device comprising:
a. a decorative assembly comprising at least one marking; and
b. a means for placing the decorative assembly about the cable, wherein the decorative assembly comprises a pair of half-shell shaped sections each having a first edge and a second edge and being hingedly connected to each other along the first edges by a hinge 19.

15. The device as claimed in claim 14, wherein the hinge is formed by a region of reduced thickness defining an integrally formed hinge.

16. The device as claimed in claim 15, wherein the second edge of one of the pair of sections comprises one or more generally tabs and the second edge of the other of the pair of sections comprises one or more grooves that cooperate with the tabs to secure the device in a closed position.

17. The device as claimed in claim 16, wherein when the device is in the closed position it has an internal diameter equal to or slightly greater than the outside diameter of the cable.

18. The device as claimed in claim 17, wherein at least one of the two sections comprises an internal stabling member that abuts the cable in the closed position.

19. The device as claimed in claim 18, wherein the two sections are mirror images of each other.

20. The device as claimed in claim 19, wherein the device further comprises a unique serial number.

21. A method for decorating at least one cable of a video game system comprising the steps of:
a. obtaining a decoration; and
b. placing the decoration about the cable.

22. The method as claimed in claim 21, wherein the decoration is a representation selected from the group consisting of a company name, a hobby, and attendance at an event.

23. The method as claimed in claim 21, wherein the decoration represents an accolade for achievement in playing a video game.

24. The method as claimed in claim 21, wherein the method is repeated with a plurality of decorations.

25. A method for archiving events comprising the steps of:
a. obtaining at least one decoration; and
b. placing the at least one decoration about a cable on a video game system wherein the decorative assembly is associated with a past event.

26. The method as claimed in claim 25, wherein the decoration is associated with a commercial enterprise.

27. The method as claimed in claim 25, wherein the decoration is associated with a video game.

28. The method as claimed in claim 25, wherein the decoration is associated with a hobby.

29. The method as claimed in claim 25, wherein the method creates a chain of decorations about the cable.

30. A method for selectively distributing a device for decorating a cable of a video game system comprising the steps of:
a. providing a user with a code at specific point during the playing of a video game;
b. allowing the user to provide the code to a distributing entity; and
c. distributing the device to the user.

31. The method as claimed in claim 30, wherein the code is presented to the player upon completing at least one specific event during the playing of the video game.

32. The method as claimed in claim 30, wherein the code is presented to the user upon the user completing the video game.

33. The method as claimed in claim 30, wherein the user provides the code to the distributing entity via a website.

34. The method as claimed in claim 30, further comprising the step of allowing the user to pay for the device.

35. The method as claimed in claim 30, further comprising the step of the user placing the device on the cable.

36. A method for providing, awarding, winning, trading, and otherwise distributing awards, tokens, indicia, and other indications of achievement, fanaticism, or devotion comprising providing a decorative assembly with a video game.

37. The method as claimed in claim 36, wherein the decorative assembly is placed a package containing the video game distributed as a single unit.

38. The method as claimed in claim 37, wherein the decorative assembly is unique to the video game.

39. The method as claimed in claim 37, wherein the decorative assembly is assigned a unique serial number.

40. The method as claimed in claim 37, wherein the decorative assembly is placed on a cable of a video game system.

41. The method as claimed in claim 39, further comprising the step of registering the unique serial number with a database.

42. A method for awarding an indication of achievement comprising the steps of:
a. allowing at least one person to compete in playing the video game; and
b. upon one of the at least one person winning the video game, the winner is given a decorative assembly.

43. The method as claimed in claim 42, wherein the loser owns the decorative assembly and winner is given the decorative assembly by the loser.

44. The method as claimed in claim 42, wherein the decorative assembly is awarded to the winner by a competition sponsor or a video game developer.

45. The method as claimed in claim 42, further comprising the step of placing the decorative assembly on a cable that is part of a video game system.

46. A decorative assembly for placing on a video game system cable, comprising first and second half shell sections that are hinged together along one edge and clip together along another other edge to encircle said cable, said first half shell section having on an external surface thereof at least one decorative marking that is readily perceptible by at least one human.
